(19) United States
(12) Patent Application Publication
(10) Pub. No.: US 2025/0128403 A1
(43) Pub. Date: Apr. 24, 2025

(54) APPARATUS AND METHOD OF USE OF A MECHANISM THAT CONVERTS ROTARY MOTION INTO LINEAR MOTION

(71) Applicant: Pramana Inc., Cambridge, MA (US)

(72) Inventors: S Jayakrishna, Karnataka (IN); Bhaskar Shetty, Karnataka (IN); Ajay Chadha, Karnataka (IN); Dipankar Das, Bangalore (IN); Rameesh Varshan, Chennai Tamil Nadu (IN); Gourisetti Ravi Teja, Vijayawada Andhra Pradesh (IN); Prasanth Perugupalli, Cary, NC (US); Abhishek Chikkanduru Nagaraj, Karnataka (IN)

(73) Assignee: Pramana Inc., Cambridge, MA (US)

(21) Appl. No.: 18/382,386

(22) Filed: Oct. 20, 2023

(51) Int. Cl. B25J 9/10

(52) U.S. Cl. CPC B25J 9/102

(57) ABSTRACT

An apparatus and method of use of a mechanism that converts rotary motion into linear motion are disclosed. The method includes mechanically connecting, using a first connecting component, a rotary component and one or more movable components, mechanically connecting, using a second connecting component, a plurality of gripping components and the one or more movable components, generating, using the rotary component, rotary motion about a rotational axis, transferring, using the first connecting component, the rotary motion to the one or more movable components, transferring, using the second connecting component, the off-axis motion of the one or more movable components to the plurality of gripping components and moving the plurality of gripping components linearly in opposite directions.

### FIELD OF THE INVENTION

The present invention generally relates to the field of mechanical devices. In particular, the present invention is directed to apparatus and method of use of a mechanism that converts rotary motion into linear motion.

### BACKGROUND

Over the years, advancements in materials science, manufacturing processes, and engineering design have led to innovations in the field of converting rotary motion to linear motion. However, there remains a need for improved mechanisms that offer enhanced performance, reduced complexity, and increased versatility across diverse applications. The present invention addresses the challenges and limitations of existing mechanisms for converting rotary motion to linear motion.

### SUMMARY OF THE DISCLOSURE

In an aspect, a method of use of a mechanism that converts rotary motion into linear motion are disclosed. The method includes mechanically connecting, using a first connecting component of at least a connecting component of at least an actuator, a rotary component of at least an actuator and one or more movable components of the at least an actuator, mechanically connecting, using a second connecting component of the at least a connecting component, a plurality of gripping components and the one or more movable components of the at least an actuator, generating, using the rotary component, rotary motion about a rotational axis, transferring, using the first connecting component, the rotary motion to the one or more movable components, wherein the rotary motion of the rotary component leads to off-axis motion of the one or more movable components, transferring, using the second connecting component, the off-axis motion of the one or more movable components to the plurality of gripping components and moving the plurality of gripping components linearly in opposite directions.

In another aspect, an apparatus of a mechanism that converts rotary motion into linear motion, wherein the apparatus includes at least an actuator configured to generate linear motion of a plurality of gripping components, wherein the at least an actuator includes a rotary component, wherein the rotary component is configured to generate rotary motion about a rotational axis, one or more movable components, wherein the rotary motion of the rotary component leads to off-axis motion of the one or more movable components and at least a connecting component including a first connecting component, wherein the first connecting component is configured to mechanically connect the rotary component and the one or more movable components and transfer the rotary motion of the rotary component to the one or more movable component and a second connecting component, wherein the second connecting component is configured to mechanically connect the plurality of gripping components and the one or more movable components and transfer the off-axis motion of the one or more movable components to the plurality of gripping components and the plurality of gripping components, wherein the plurality of gripping components is configured to move linearly in opposite directions.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a block diagram of an exemplary apparatus of a mechanism that converts rotary motion into linear motion;

FIG. 2A illustrates an exemplary embodiment of an apparatus of a mechanism that converts rotary motion into linear motion in an open configuration;

FIG. 2B illustrates an exemplary embodiment of an apparatus of a mechanism that converts rotary motion into linear motion in a closed configuration;

FIG. 3A illustrates an exemplary embodiment of a plurality of gripping components in an open position of an open configuration;

FIG. 3B illustrates an exemplary embodiment of a plurality of gripping components in a second closed position of a closed configuration holding a gripping object;

FIG. 3C illustrates an exemplary embodiment of a plurality of gripping components in a first closed position of a closed configuration without holding a gripping object;

FIG. 3D illustrates an exemplary embodiment of one of a plurality of gripping components missing a grip enhancing component in a closed configuration;

FIGS. 4A-F illustrate exemplary embodiments of a plurality of gripping components placing a gripping object on a remote device;

FIG. 5 illustrates an exemplary embodiment of the use of an apparatus of a mechanism that converts rotary motion into linear motion;

FIG. 6 illustrates a flow diagram of an exemplary method of use of a mechanism that converts rotary motion into linear motion; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods of use of a mechanism that converts rotary motion into linear motion are disclosed. The method includes mechanically connecting, using a first connecting component of at least a connecting component of at least an actuator, a rotary component of at least an actuator and one or more movable components of the at least an actuator, mechanically connecting, using a second connecting component of the at least a connecting component, a plurality of gripping components and the one or more movable components of the at least an actuator, generating, using the rotary component, rotary motion on an axis passing through a center of the rotary component perpendicular to a surface of the rotary component, transferring, using the first connecting component, the rotary motion to the one or more movable components, wherein the rotary motion of the rotary component leads to off-axis motion of the one or more movable components, transferring, using the second connecting component, the off-axis motion of the one or more movable components to the plurality of gripping components and moving the plurality of gripping components linearly in opposite directions . . . . Exemplary embodiments illustrating aspects of the present disclosure are described below in the context of several specific examples.

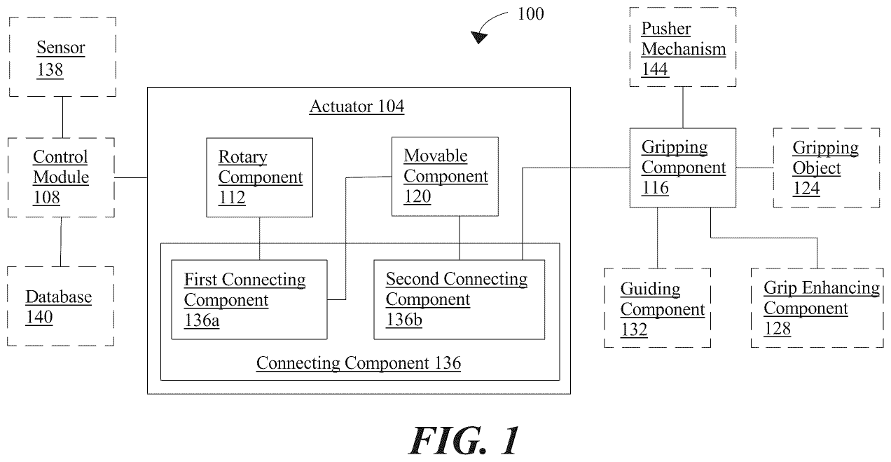

Referring now to FIG. 1, a block diagram of exemplary apparatus 100 of a mechanism that converts rotary motion into linear motion is illustrated. Apparatus 100 includes at least an actuator 104. For the purposes of this disclosure, an “actuator” is a component of a machine that is responsible for moving and/or controlling a mechanism or system. Actuator 104 may, in some cases, require a control signal and/or a source of energy or power. In some cases, a control signal may be relatively low energy. Exemplary control signal forms include electric potential or current, pneumatic pressure or flow, or hydraulic fluid pressure or flow, mechanical force/torque or velocity, or even human power. In some cases, actuator 104 may have an energy or power source other than control signal. This may include a main energy source, which may include for example electric power, hydraulic power, pneumatic power, mechanical power, and the like. In some cases, upon receiving a control signal, actuator 104 may respond by converting source power into mechanical motion. As a non-limiting example, actuator 104 may receive a control signal from a control module 108. The control module 108 disclosed herein is further described below. In some cases, actuator 104 may be understood as a form of automation or automatic control.

With continued reference to FIG. 1, in some embodiments, actuator 104 may include a hydraulic actuator. In some cases, hydraulic actuator may consist of a cylinder or fluid motor that uses hydraulic power to facilitate mechanical operation. In a non-limiting example, output of hydraulic actuator may include mechanical motion, such as, without limitation linear, rotatory, or oscillatory motion. In some cases, hydraulic actuator may employ a liquid hydraulic fluid. As liquids, in some cases, are incompressible, a hydraulic actuator can exert large forces. Additionally, as force is equal to pressure multiplied by area, in some cases, hydraulic actuators may act as force transformers with changes in area (e.g., cross sectional area of cylinder and/or piston). An exemplary hydraulic cylinder may consist of a hollow cylindrical tube within which a piston can slide. In some cases, hydraulic cylinder may be considered single acting. The single acting may be used when fluid pressure is applied substantially to just one side of a piston. Consequently, a single acting piston can move in only one direction. In some cases, a spring may be used to give a single acting piston a return stroke. In some cases, hydraulic cylinder may be double acting. The double acting may be used when pressure is applied substantially on each side of a piston; any difference in resultant force between the two sides of the piston causes the piston to move.

With continued reference to FIG. 1, in some embodiments, actuator 104 may include a pneumatic actuator. In some cases, pneumatic actuator may enable considerable forces to be produced from relatively small changes in gas pressure. In some cases, pneumatic actuator may respond more quickly than other types of actuators, for example hydraulic actuators. In some cases, pneumatic actuator may use compressible fluid. In some cases, pneumatic actuator may operate on compressed air. In a non-limiting example, operation of hydraulic and/or pneumatic actuators may include control of one or more valves, circuits, fluid pumps, and/or fluid manifolds.

With continued reference to FIG. 1, actuator 104 may be an electric actuator. In some embodiments, electric actuator may include any electromechanical actuators, linear motors, and the like. In some cases, actuator 104 may include an electromechanical actuator. In some cases, electromechanical actuator may convert a rotational force of an electric rotary motor into a linear movement to generate a linear movement through a mechanism. Exemplary mechanisms include rotational to translational motion transformers, such as, without limitation a belt, a screw, a crank, a cam, a linkage, a scotch yoke, and the like. In some cases, control of electromechanical actuator may include control of electric motor, for instance a control signal may control one or more electric motor parameters to control electromechanical actuator. As a non-limiting example, electric motor may receive control signal from control module 108. Exemplary non-limitation electric motor parameters include rotational position, input torque, velocity, current, and potential. In some cases, electric actuator may include a linear motor. Linear motors, in some cases, may differ from electromechanical actuators, as power from linear motors is output directly as translational motion, rather than output as rotational motion and converted to translational motion. In some cases, linear motor may cause lower friction losses than other devices. In some cases, linear motors may be further specified into at least 3 different categories, including flat linear motor, U-channel linear motors and tubular linear motors. Linear motors, in some cases, may be directly controlled by a control signal for controlling one or more linear motor parameters. As a non-limiting example, linear motor may receive control signal from control module 108. Exemplary linear motor parameters include without limitation position, force, velocity, potential, and current.

With continued reference to FIG. 1, an “electric motor,” for the purposes of this disclosure, is a device that converts electrical energy into mechanical energy. Electric motor, in some cases, may be driven by direct current (DC) electric power; for instance, a motor may include a brushed DC motor, or the like. Electric motor, in some cases, may be driven by electric power having varying or reversing voltage levels, such as alternating current (AC) power as produced by an alternating current generator and/or inverter, or otherwise varying power, such as produced by a switching power source. Electric motor may include, in a non-limiting example, a brushless DC electric motor, a permanent magnet synchronous motor, a switched reluctance motor, and/or an induction motor; persons skilled in the art, upon reviewing the entirety of this disclosure, will be aware of various alternative or additional forms and/or configurations that a motor may take or exemplify as consistent with this disclosure. In addition to inverter and/or switching power source, a circuit driving motor may include electronic speed controllers or other components for regulating motor speed, rotation direction, torque, and the like.

With continued reference to FIG. 1, in some embodiments, actuator 104 may include a mechanical actuator. In some cases, mechanical actuator may function to execute movement by converting one kind of motion, such as rotary motion, into another kind, such as linear motion. An exemplary mechanical actuator may include a rack and pinion. In some cases, a mechanical power source, such as a power take off may serve as power source for the mechanical actuator. The mechanical actuators may employ any number of mechanisms, including for example without limitation gears, rails, pulleys, cables, linkages, and the like.

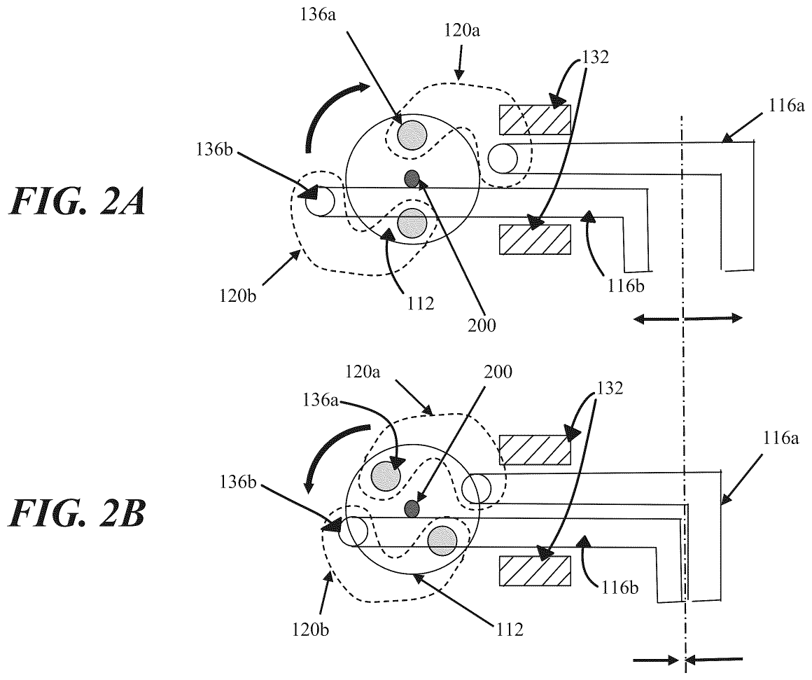

With continued reference to FIG. 1, actuator 104 includes a rotary component 112. For the purposes of this disclosure, a “rotary component” is a device that converts forms of energy into rotational motion. Rotary component 112 is configured to generate rotary motion about a rotational axis. In a non-limiting example, rotary component 112 may be configured to generate rotary motion on an axis passing through a center of the rotary component 112 perpendicular to a surface of the rotary component 112. For the purposes of this disclosure, “rotary motion,” also called “rotational motion,” refers to the type of motion in which an object or component rotates or revolves around a fixed axis or point. In some cases, rotary component 112 may be configured to rotate clockwise and/or counter-clockwise direction about a rotational axis. In a non-limiting example, rotary component 112 may be configured to rotate in a first direction (e.g., clockwise and/or counter-clockwise direction) on axis passing through the center of rotary component 112 perpendicular to the surface of rotary component 112. In some embodiments, rotary component may be configured to rotate in a first direction and/or a second direction about a rotational axis. First direction and second direction may be opposing directions; as a non-limiting example, first direction may be clockwise while second direction may be counter-clockwise or first direction may be counter-clockwise while second direction may be clockwise. In some embodiments, rotating the rotary component in first direction about the rotational axis moves the plurality of gripping components into a closed configuration as a first gripping component gets pulled while, concurrently, a second gripping component gets pushed. In some embodiments, rotating the rotary component in second direction about the rotational axis moves the plurality of gripping components into an open configuration as a first gripping component gets pushed while, concurrently, a second gripping component gets pulled. In a non-limiting example, rotary component 112 may rotate counter-clockwise direction on axis passing through the center of rotary component 112 perpendicular to the surface of rotary component 112 to move a plurality gripping components 116 into a closed configuration as shown in FIG. 2B. In another non-limiting example, rotary component 112 may rotate clockwise direction on axis passing through the center of rotary component 112 perpendicular to the surface of rotary component 112 to move a plurality gripping components 116 into an open configuration as shown in FIG. 2A. In another non-limiting example, rotary component 112 may rotate clockwise direction about a rotational axis to move a plurality gripping components 116 into closed, open or partially open configuration. In another non-limiting example, rotary component 112 may rotate counter-clockwise direction about a rotational axis to move a plurality gripping components 116 into closed, open or partially open configuration. As a non-limiting example, rotary component may include rotary disk, pinion, pulley, gear, rod, shaft, wheel, or the like. For the purposes of this disclosure, a “rotary disk,” also called “rotary disc” is a flat, circular object or component that is designed to rotate around its central axis. In some cases, rotary component 112 may include steel, cast iron, brass, bronze, plastic, aluminum, stainless steel, carbon fibers, or the like. In some cases, rotary component 112 may include a diverse range of sizes and configurations tailored to accommodate a spectrum of operational contexts. As a non-limiting example, rotary component 112 may be circular, oval, rectangular, or the like. As a non-limiting example, rotary component 112 may be flat, round, uneven, or the like. In some embodiments, rotary component 112 may include a plurality of rotary components 112. As a non-limiting example, two intermeshing gears may be used. In some cases, rotary component 112 may be configured to rotate using a motor. In a non-limiting example, motor may provide the necessary energy or force to drive rotary component into a rotary motion. The motor disclosed herein may be consistent with any motor described in the entirety of this disclosure. As a non-limiting example, motor may include electric, hydraulic, pneumatic, manually powered motor. In some embodiments, control module 108 may transmit a control signal to motor to rotate rotary component 112.

With continued reference to FIG. 1, actuator 104 includes one or more movable components 120. For the purposes of this this disclosure, a “movable component” is a device that moves along with a rotary component. Rotary motion of rotary component 112 leads to off-axis motion of one or more movable components 120. For the purposes of this disclosure, “off-axis motion” is the movement of an object or component in a direction that is not aligned with its central axis motion. In a non-limiting example, movable component 120 may deviate from an axis passing through the center of movable component 120 perpendicular to the surface of movable component 120. In another non-limiting example, movable component 120 may not include a fixed axis of its movement. For example, and without limitation, as movable component 120 is mechanically coupled to rotary component 112 as described below, movable component 120 may passively move in off-axis motion along with the rotary motion of rotary component 112. In some cases, movable component 120 may include cam, follower, pinion, rack, gear, belt, or the like. For the purposes of this disclosure, a “cam” is a specially shaped component that is designed to impart controlled, reciprocating or oscillating motion to another component. In a non-limiting example, cam of movable component 120 may impart controlled, reciprocating or oscillating motion to a plurality of gripping components 116 as described below. In some cases, movable component 120 may include circular, semicircular, eccentric disc, arc-shaped, non-circular, tooth, or other shape thereof. In a non-limiting example, apparatus 100 may include two movable components 120 as shown in FIGS. 2A-B, where two movable components 120 may be connected to the same rotary component 112 and may move simultaneously but in opposite directions. This, continuing non-limiting example, may allow gripping components 116 to move in opposite directions of each other to open or closed configuration. In a non-limiting example, two movable components 120 may be connected to the same rotary component 112 but different gripping components 116, such as but not limited to first gripping component 116a and second gripping component 116b, as shown in FIG. 2A-B.

With continued reference to FIG. 1, apparatus 100 includes a plurality of gripping components 116. For the purposes of this disclosure, a “gripping component” is a mechanical or structural component designed to hold, grasp, or secure objects or materials. In some cases, gripping component 116 may be configured to grip a gripping object 124. For the purposes of this disclosure, a “gripping object” is an item or material that is designed to be held or grasped by a gripping component. Exemplary gripping object 124 may include microscope slides, workpieces, tools, parts, products, raw materials, or the like. For the purposes of this disclosure, a “microscope slide” is a thin flat component used to hold objects for examination under a microscope. In a non-limiting example, gripping object 124 may include glass, plastic, or the like. In a non-limiting example, gripping component 116 may grip a gripping object 124 without damaging it, then place gripping object 124 on a designated location without damaging it. For example, and without limitation, gripping component 116 may be configured to pick up gripping object 124 from a storage of gripping objects 124, carry gripping object 124 to a remote device, such as but not limited to scanner, microscope, or any other location thereof and carry back to a storage of scanned, examined or used gripping objects 124.

With continued reference to FIG. 1, in some cases, apparatus 100 may include a grip enhancing component 128. For the purposes of this disclosure, a “grip enhancing component” is a substance or element designed to improve the grip, or friction between gripping components and a gripping object it is holding or manipulating. In some cases, grip enhancing component 128 may be attached, inserted, embedded, coated, or the like to gripping component 116. In a non-limiting example, grip enhancing component 128 may include rubber coating, textured surface, adhesive tape or pad, vacuum or suction cup, magnetic gripper, or the like. As a non-limiting example, rubber coating of grip enhancing component 128 may include nitrile, natural, neoprene, ethylene propylene diene monomer, silicone, polyurethane, butyl, styrene-butadiene, fluoroelastomers, or the like. In some embodiments, grip enhancing component 128 may be configured to create large surface area of contact between gripping components 116 and gripping object 124. In some embodiments, grip enhancing component 128 may be configured to increase a coefficient of friction between gripping components 116 and gripping object 124. For the purposes of this disclosure, a “coefficient of friction” is a number that represents the amount of friction between two surfaces.

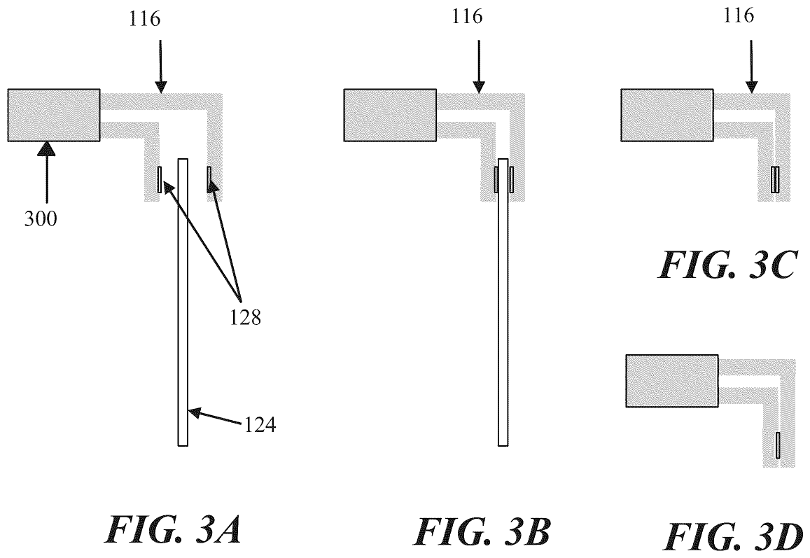

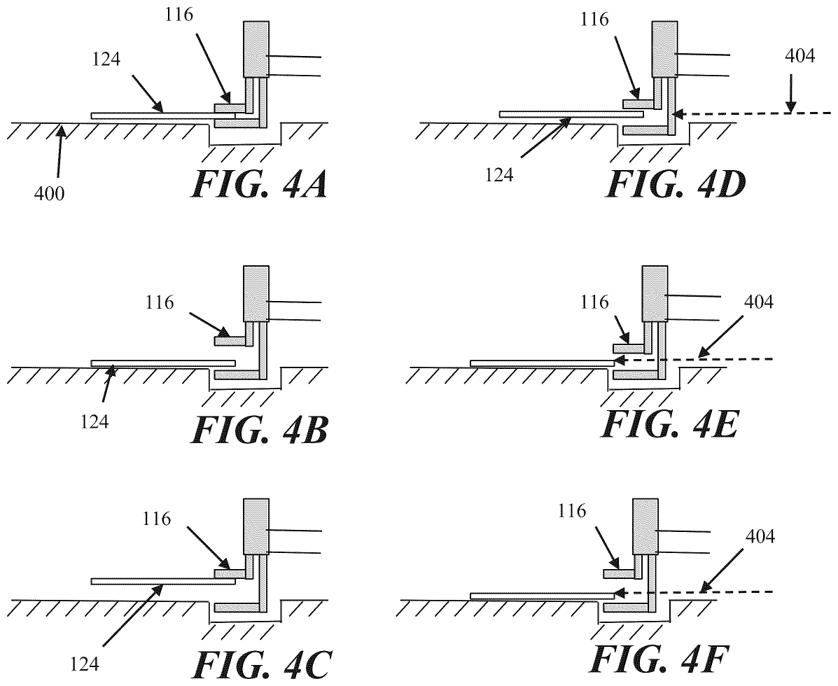

With continued reference to FIG. 1, a plurality of gripping components 116 is configured to move linearly (linear motion) in opposite directions of each other. As a non-limiting example, gripping components 116 may move to an open configuration. For the purposes of this disclosure, an “open configuration” of gripping components refers to a state or mode in which the gripping components are in a position that allows them to receive or release a gripping object. The open configuration of gripping components 116 is further described below. An exemplary configuration of open configuration of gripping components 116 is illustrated in FIGS. 2A and 3A. As another non-limiting example, gripping components 116 may move to a closed configuration. For the purposes of this disclosure, a “closed configuration” of gripping components refers to a state or mode in which the gripping components are positioned, adjusted, or engaged in a way that minimizes or eliminates gaps, openings, or spaces between them. In a non-limiting example, gripping component 116 may hold gripping object 124 in closed configuration. In another non-limiting example, gripping component 116 may be configured to remain in closed configuration until gripping object 124 is close to a location to be dropped. The closed configuration of gripping components 116 is further described below. An exemplary configuration of closed configuration of gripping components 116 is illustrated in FIGS. 2B and 3B-4A. As another non-limiting example, gripping components 116 may move to a partially open configuration. For the purposes of this disclosure, a “partially open configuration” of gripping components refers to a state or mode in which the gripping components are positioned, adjusted, or engaged in a way they are not fully closed or engaged, allowing for some degree of opening. In a non-limiting example, partially open configuration of gripping components 116 may allow movement or separation of gripping object 124 from gripping components 116 without damaging the gripping object 124. The partially open configuration of gripping components 116 is further described below. An exemplary configuration of partially open configuration of gripping components 116 is illustrated in FIGS. 4D-E.

With continued reference to FIG. 1, in some embodiments, apparatus 100 may include a guiding component 132. For the purposes of this disclosure, a “guiding component” is a mechanical or structural element that is designed to direct or guide the linear motion of gripping components. As a non-limiting example, guiding component 132 may include bearings, guides, rails, sliders, or the like. In some cases, guiding component 132 may be configured to provide linear guidance, meaning it may direct gripping components 116 to move in linear motion along a specified path. In some cases, guiding component 132 may be configured to maintain the alignment of gripping components 116, preventing deviations or misalignment during linear motion. In some embodiments, there may be friction reducing mechanisms, such as but not limited to bearings, lubricants, low-friction coatings, or the like, between guiding component 132 and gripping components 116.

With continued reference to FIG. 1, actuator 104 includes at least a connecting component 136. For the purposes of this disclosure, a “connecting component” is a device or component that joins or connects two or more other components. As a non-limiting example, connecting component 136 may include cylindrical pins or dowels, fasteners, bolts, screws, nuts, washers, rivets, adhesive, sealants, welding, interlocking feature, or the like. In some cases, connecting component 136 may include steel, stainless steel, brass, plastic, or the like. In some cases, connecting component 136 may include various shapes and sizes.

With continued reference to FIG. 1, connecting component 136 includes a first connecting component 136a. First connecting component 136a is configured to mechanically connect rotary component 112 and movable component 120. In a non-limiting example, first connecting component 136a may fixedly connect rotary component 112 and a first end of movable component 120. In another non-limiting example, first connecting component 136a may movably connect rotary component 112 and a first end of movable component 120 as described below. For the purposes of this disclosure, “fixedly connected” refers to a state or condition in which two or more components or parts are securely and permanently attached to each other in a way that prevents relative movement or separation. In a non-limiting example, fixedly connecting first connecting component 136a may include welding, bolting, adhesive bonding, or any other method thereof. First connecting component 136a is transfer rotary motion of rotary component 112 to movable component 120. In a non-limiting example, as first connecting component 136a fixedly connects rotary component 112 and movable component 120, rotary motion of rotary component 112 may lead to off-axis motion of movable component 120.

With continued reference to FIG. 1, as used herein, a person of ordinary skill in the art would understand “mechanically coupled” to mean that at least a portion of a device, component, or circuit is connected to at least a portion of another device, component, or circuit via a mechanical coupling. Said mechanical coupling can include, for example, rigid coupling, such as beam coupling, bellows coupling, bushed pin coupling, constant velocity, split-muff coupling, diaphragm coupling, disc coupling, donut coupling, elastic coupling, flexible coupling, fluid coupling, gear coupling, grid coupling, Hirth joints, hydrodynamic coupling, jaw coupling, magnetic coupling, Oldham coupling, sleeve coupling, tapered shaft lock, twin spring coupling, rag joint coupling, universal joints, or any combination thereof. In some instances, the terminology “mechanically connected” may be used in place of mechanically coupled in this disclosure.

With continued reference to FIG. 1, connecting component 136 includes a second connecting component 136b. Second connecting component 136b is configured to mechanically connect gripping component 116 and movable component 120. In a non-limiting example, second connecting component 136b may fixedly connect or movably connect gripping component 116 and a second end of movable component 120. In a non-limiting example, second connecting component 136b may movably connect or movably connect gripping component 116 and a second end of movable component 120. In another non-limiting example, second connecting component 136b may movably connect gripping component 116 and a second end of movable component 120. For the purposes of this disclosure, “movably connected” refers to a state or condition in which two or more components or parts are connected in a way that allows them to move relative to each other while maintaining a degree of connection or attachment. In a non-limiting example, movable connection may allow controlled or limited motion, such as rotation, translation, or oscillation, without complete separation of two or more components. As a non-limiting example, movably connecting gripping component 116 and movable component 120 may include hinges, joints, pivots, sliders, linkages, or the like. Second connecting component 136b is configured to transfer off-axis motion of movable component 120 to gripping component 116. In a non-limiting example, as second connecting component 136b movably connects gripping component 116 and movable component 120, off-axis motion of movable component 120 may be transferred to gripping component 116. This, continuing non-limiting example, may lead linear motion of gripping component 116.

With continued reference to FIG. 1, for example, and without limitation, rotating rotary component 112 (rotary motion) in clockwise direction on axis passing through the center of rotary component 112 perpendicular to the surface of rotary component 112 may lead to the movement of movable component 120 in off-axis motion as movable component 120 may be fixedly connected or movably connected to rotary component 112 using first connecting component 136a, then off-axis motion of movable component 120 may lead the movement of gripping component 116 in linear motion as a second end of movable component 120 and a first end of gripping component 116 may be fixedly connected or movably connected using second connecting component 136b, where the linear motion of gripping component 116 may move first gripping component 116 and second gripping component 116 in opposite direction to each other, increasing the gap between second ends of first gripping component 116 and second gripping component 116 (open configuration as shown in FIG. 2A). In a non-limiting example, rotary component 112 may rotate clockwise direction on axis passing through the center of rotary component 112 perpendicular to the surface of rotary component 112 to move a plurality gripping components 116 into open configuration as shown in FIG. 2A.

With continued reference to FIG. 1, for example, and without limitation, rotating rotary component 112 (rotary motion) in counter-clockwise direction on axis passing through the center of rotary component 112 perpendicular to the surface of rotary component 112 may lead to the movement of movable component 120 in off-axis motion as movable component 120 may be fixedly connected or movably connected to rotary component 112 using first connecting component 136a, then off-axis motion of movable component 120 may lead the movement of gripping component 116 in linear motion as a second end of movable component 120 and a first end of gripping component 116 may be fixedly connected or movably connected using second connecting component 136b, where the linear motion of gripping component 116 may move first gripping component 116 and second gripping component 116 in opposite directions to each other, decreasing the gap between second ends of first gripping component 116 and second gripping component 116 (closed configuration as shown in FIG. 2B). In a non-limiting example, rotary component 112 may rotate in a counter-clockwise direction about an axis passing through the center of rotary component 112 perpendicular to the surface of rotary component 112 to move a plurality gripping components 116 into a closed configuration as shown in FIG. 2B.

With continued reference to FIG. 1, in some embodiments, apparatus 100 may include a control module 108. For the purposes of this disclosure, a “control module” is an electronic component, device or system that monitors, regulates, controls functions or processes within the system. In some embodiments, control module 108 may include at least a processor. Processor may include, without limitation, any processor described in this disclosure. Control module 108 may be included in a computing device. Control module 108 may include any computing device as described in this disclosure, including without limitation a microcontroller, microprocessor, digital signal processor (DSP) and/or system on a chip (SoC) as described in this disclosure. Control module 108 may include, be included in, and/or communicate with a mobile device such as a mobile telephone or smartphone. Control module 108 may include a single computing device operating independently, or may include two or more computing device operating in concert, in parallel, sequentially or the like; two or more computing devices may be included together in a single computing device or in two or more computing devices. Control module 108 may interface or communicate with one or more additional devices as described below in further detail via a network interface device. Network interface device may be utilized for connecting control module 108 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Control module 108 may include but is not limited to, for example, a computing device or cluster of computing devices in a first location and a second computing device or cluster of computing devices in a second location. Control module 108 may include one or more computing devices dedicated to data storage, security, distribution of traffic for load balancing, and the like. Control module 108 may distribute one or more computing tasks as described below across a plurality of computing devices of computing device, which may operate in parallel, in series, redundantly, or in any other manner used for distribution of tasks or memory between computing devices. Control module 108 may be implemented, as a non-limiting example, using a “shared nothing” architecture.

With continued reference to FIG. 1, control module 108 may be designed and/or configured to perform any method, method step, or sequence of method steps in any embodiment described in this disclosure, in any order and with any degree of repetition. For instance, control module 108 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Control module 108 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, in some embodiments, control module 108 may include a memory communicatively connected to control module 108 or processor. For the purposes of this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, in some embodiments, control module 108 may be configured to receive a gripping force of gripping components 116. In a non-limiting example, sensor 138 may be configured to detect a gripping force of gripping components 116 and transmit the data to control module 108. For the purposes of this disclosure, a “gripping force” is the amount of mechanical force or pressure exerted by gripping components on a gripping object that is being held by them. As a non-limiting example, gripping force may include newtons (N), pounds-force (lbf), or the like. In some embodiments, gripping component 116 may include a gripping threshold. For the purposes of this disclosure, a “gripping threshold” is a limit of the amount of mechanical force that can be exerted by gripping components. As a non-limiting example, gripping threshold may include a limit of current to a motor. In some cases, gripping threshold may be predefined or manually input by a user, wherein the user may include expert user. In some cases, gripping components 116 may include different gripping threshold as a function of thickness of gripping object 124. As a non-limiting example, gripping threshold for a first gripping object that is thicker than a second gripping object may be lower than gripping threshold for the second gripping object. In some embodiments, control module 108 may be configured to execute a control signal for gripping components 116 to hold a gripping object 124 using gripping force within gripping threshold.

With continued reference to FIG. 1, in some cases, apparatus 100 may include at least a sensor 138 communicatively connected to control module 108. In a non-limiting example, control module 108 may be configured to receive gripping force from sensor 138 communicatively connected to control module 108. For the purposes of this disclosure, a “sensor” is a device that produces an output signal for the purpose of sensing a physical phenomenon. For example, and without limitation, sensor 138 may transduce a detected phenomenon, such as without limitation, temperature, voltage, current, pressure, speed, motion, light, moisture, and the like, into a sensed signal. Sensor 138 may output the sensed signal. Sensor 138 may include any computing device as described in the entirety of this disclosure and configured to convert and/or translate a plurality of signals detected into electrical signals for further analysis and/or manipulation. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. Any datum captured by sensor 138 may include circuitry, computing devices, electronic components or a combination thereof that translates into at least an electronic signal configured to be transmitted to another electronic component. In a non-limiting embodiment, sensor 138 may include a plurality of sensors 126 comprised in a sensor suite. In one or more embodiments, and without limitation, sensor may include a plurality of sensors 126.

With continued reference to FIG. 1, in some embodiments, sensor 138 may include a current sensor. For the purposes of this disclosure, a “current sensor” is an electronic device designed to measure the electric current flowing through a conductor or circuit. In some cases, current sensors may measure the magnitude of electric current in a circuit, providing readings in units such as amperes (A) or milliamperes (mA). In some cases, control module 108 may receive electrical current flowing though a motor that delivers power to rotary component 112 from current sensor. In some embodiments, control module 108 may be communicatively connected to motor. In a non-limiting example, if the current exceeds a gripping threshold, control module 108 may respond by reducing motor power, stopping the motor, or providing an alert. For example, and without limitation, control module 108 may control the motor's speed, direction, and braking as a function of detection of current of motor and gripping threshold.

With continued reference to FIG. 1, in some embodiments, sensor 138 may include a force sensor. For the purposes of this disclosure, a “force sensor” is a sensor that converts an input mechanical load, weight, tension, compression or pressure into an electrical output signal. As a non-limiting example, force sensor may include a tension force sensor, compression force sensor, tension and compression force sensor, and the like. As another non-limiting example, force sensor may include a strain gauge, load cell, piezoelectric sensor, capacitive sensor, magnetic sensor, and the like. In some embodiments, force sensor may be configured to transform a pressure into an analogue electrical signal. In some embodiments, force sensor may be configured to transform a force into a digital signal. In a non-limiting example, if the force exceeds a gripping threshold, control module 108 may respond by reducing motor power, stopping the motor, modifying closed position of closed configuration, or providing an alert. For example, and without limitation, control module 108 may control position of gripping components as a function of gripping force of gripping components 116 and gripping threshold.

With continued reference to FIG. 1, in some embodiments, sensor 138 may include an encoder. For the purposes of this disclosure, an “encoder” is a device that converts mechanical motion into an electrical signal that can be interpreted to determine the position, speed, or direction of movement. In some embodiments, encoder may include rotary encoder that measures the rotational movement of an object. As a non-limiting example, rotary encoder may measure rotary motion of rotary component 112, movement of movable component 120, or the like. In some embodiments, encoder may include linear encoder that measures the linear movement along a straight path. As a non-limiting example, linear encoder may measure linear motion of gripping components 116, movement of movable component 120, or the like. In some embodiments, encoder may include optical, magnetic, incremental, absolute encoder, or the like.

With continued reference to FIG. 1, in some embodiments, sensor 138 may include a hall effect sensor. For the purposes of this disclosure, a “hall effect sensor” is a device that detects the presence of a magnetic field. Hall effect sensor operates on the principle of the Hall effect, which describes the generation of a voltage difference (Hall voltage) across an electrical conductor when it is subjected to a magnetic field perpendicular to the current flow. In a non-limiting example, hall effect sensor may measure speed and/or position of rotary component 112, movable component 120, gripping component 116, or the like. For example, and without limitation, hall effect sensor may measure proximity or position of first gripping component 116a and second gripping component 116b.

With continued reference to FIG. 1, in some embodiments, control module 108 may be configured to receive a closed position of gripping components 116 in a closed configuration without holding gripping object 124 using the rotary motion of the rotary component from sensor 138. In a non-limiting example, sensor 138 may be configured to detect a closed position of gripping components 116 in a closed configuration without holding gripping object 124. For the purposed of this disclosure, a “closed position” is the specific placement of gripping components required to be in a closed configuration of gripping components. As a non-limiting example, closed position of gripping components 116 may include a specific number, distance, amount, or value of rotation (rotary motion) of rotary component 112 to lead gripping component 116 to be in a closed configuration. In some cases, a specific number, distance, amount, or value of rotation (rotary motion) of rotary component 112 may lead gripping components 116 into a specific closed position. For example, and without limitation, closed position may include angular displacement, arc length, the number of rotation of rotary motion, direction of rotary motion, or the like. In a non-limiting example, closed position may include a value of the angle that rotary component 112 (angular displacement) has moved counter-clockwise or clockwise direction (direction of rotary motion) to lead gripping components 116 to be in a closed configuration. In another non-limiting example, closed position may include a value of the number of rotation that rotary component 112 has to rotate in either counter-clockwise or clockwise direction to lead gripping components 116 to be in a closed configuration. In a non-limiting example, control module 108 may measure the specific value of rotary motion of rotary component 112 that leads gripping components 116 to be in closed configuration without holding gripping object 124. For example, and without limitation, closed position may include angular displacement of 90 degree in counter-clockwise direction of rotary motion of rotary component 112 for gripping components in a certain closed configuration. In some cases, control module 108 may determine open position of gripping components 116 to be larger than the thickness of gripping object 124. In a non-limiting example, control module 108 may determine an open position of gripping component 116 to include a value of angular displacement, arc length, the number of rotation, or the like, more than closed position, where the value of angular displacement, arc length, the number of rotation, or the like may be predefined by a user. In some cases, the value of angular displacement, arc length, the number of rotation passing through one point, or the like may be stored in a database 140. In some cases, the set amount of angular displacement, arc length, the number of rotation, or the like may be retrieved from a database 140.

With continued reference to FIG. 1, in some cases, control module 108 may determine an open position of gripping component 132 in an open configuration as a function of a closed position of gripping component 116 in a closed configuration without holding gripping object 124. For the purposed of this disclosure, an “open position” is the specific placement of gripping components required to be in an open configuration of gripping components. As a non-limiting example, open position of gripping components 116 may include a specific number, distance, amount, or value of rotation (rotary motion) of rotary component 112 to lead gripping component 116 to be in an open configuration. For example, and without limitation, open position may include a value of angular displacement or arc length, the number of rotation of rotary motion, direction of rotary motion, or the like. For example, and without limitation, open position may include a value of angular displacement of 120 degree in clockwise direction of rotary motion of rotary component 112 from closed position for gripping components to be in an open configuration. In a non-limiting example, open position may include a value of the angle that rotary component 112 (angular displacement) has moved counter-clockwise or clockwise direction (direction of rotary motion) to lead gripping components 116 to be in an open configuration. In another non-limiting example, open position may include a value of the number of rotation that rotary component 112 has to rotate in either counter-clockwise or clockwise direction to lead gripping components 116 to be in an open configuration. In some cases, control module 108 may determine open position of gripping components 116 to be larger than the thickness of gripping object 124. In a non-limiting example, control module 108 may determine an open position of gripping component 116 to include a set amount of angular displacement, arc length, the number of rotation, or the like more than closed position, where the set amount of angular displacement, arc length, the number of rotation, or the like may be predefined by a user. In some cases, the set amount of angular displacement, arc length, the number of rotation, or the like may be stored in a database 140. In some cases, the set amount of angular displacement, arc length, the number of rotation, or the like may be retrieved from a database 140.

With continued reference to FIG. 1, in some embodiments, control module 108 may be configured to receive a first closed position of gripping components 116 in a closed configuration holding gripping object 124 using rotary motion of rotary component 112 from sensor 138. In a non-limiting example, sensor 138 may be configured to detect a first closed position of gripping components 116 in a closed configuration holding gripping object 124 using rotary motion of rotary component 112. For example, and without limitation, force sensor may detect gripping force from gripping components 116 and transmit it to control module 108. Then, continuing the non-limiting example, control module 108 may determine if gripping component 116 is holding gripping object 124 or in contact with another gripping component 116 (first gripping component 116 and second gripping component 116 in contact with each other in closed configuration) by comparing the force received from force sensor with a force threshold. For the purposes of this disclosure, a “gripping force threshold” is a limit of the value of the force detected from gripping components. As a non-limiting example, gripping force threshold may include a limit of the value of the force for determining gripping component 116 holding gripping object 124 or in contact with another gripping component 116. In a non-limiting example, if gripping force detected by force sensor is equal or higher than a gripping force threshold that includes a predetermined value of gripping force when gripping component 116 is holding gripping object 124, then control module 108 may determine that gripping component 116 is holding gripping object 124. In a non-limiting example, if gripping force detected by force sensor is lower than a gripping force threshold that includes a predetermined value of gripping force when gripping component 116 is in contact with other gripping component 116, then control module 108 may determine that gripping component 116 not in an open position or partially open and/or not holding gripping object 124. In a non-limiting example, control module 108 may be configured to receive first closed position from sensor 138. In a non-limiting example, sensor 138 may be configured to detect a change in arc length, degree of rotation, or the like of rotary motion of rotary component 112. In some cases, control module 108 may be configured to estimate a thickness of gripping object 124 as a function of a first closed position and a second closed position. For the purposes of this disclosure, a “first closed position” is the closed position of gripping components 116 in a closed configuration without holding a gripping object. For the purposes of this disclosure, a “second closed position” is the closed position of gripping components in a closed configuration holding a gripping object. As a non-limiting example, control module 108 may calculate the difference between the first closed position and the second closed position and calculated the thickness of gripping object 124 as a function of the difference. In some cases, control module 108 may include a predetermined conversion factor that maps difference in the positions to millimeters or any measurements thereof. For example, and without limitation, control module 108 may be configured to estimate the thickness of gripping object 124 by calculating the arc length of the difference of angular displacements of the first closed position and the second closed position. In some cases, the arc length can be derived using the formula: ArcLength=(2×π×radius)×(angle/360). Persons skilled in the art, upon review the entirety of this disclosure, may appreciate various methods of estimating the thickness of gripping object 124 as a function of the first closed position and the second closed position. In some cases, first closed position and/or second closed position may be stored in a database 140. In some cases, first closed position and/or second closed position may be retrieved from a database 140. In some cases, a user may manually input first closed position and/or second closed position.

With continued reference to FIG. 1, in some embodiments, control module 108 may be communicatively connected with database 140. For example, and without limitation, in some cases, database 140 may be local to control module 108. In another example, and without limitation, database 140 may be remote to control module 108 and communicative with control module 108 by way of one or more networks. The network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure control module 108 connect directly, dynamically, and non-hierarchically to as many other computing devices as possible. A “network topology” as used in this disclosure is an arrangement of elements of a communication network. The network may use an immutable sequential listing to securely store database 140. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

With continued reference to FIG. 1, in some embodiments, database 140 may be implemented, without limitation, as a relational database, a key-value retrieval database such as a NOSQL database, or any other format or structure for use as a database that a person skilled in the art would recognize as suitable upon review of the entirety of this disclosure. Database 140 may alternatively or additionally be implemented using a distributed data storage protocol and/or data structure, such as a distributed hash table or the like. Database 140 may include a plurality of data entries and/or records as described above. Data entries in a database 140 may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, control module 108 may be configured to calculate a difference between a first closed position and a previously used first closed position of a plurality of gripping components 116, wherein the first closed position comprises different closed position than the previously used first closed position. For the purposes of this disclosure, a “previously used first closed position” is a first closed position of gripping components that is used for previous operation of an apparatus. In some cases, previously used first closed position may be stored in a database 140. In some cases, previously used first closed position may be retrieved from a database 140. In some cases, a user may manually input previously used first closed position. As a non-limiting example, previously used first closed position may be predetermined. In some cases, control module 108 may compare any numerical values of first closed position and previously used first closed position. In a non-limiting example, first closed position and previously used first closed position may be equivalent, then control module 108 may not update the first closed position of a plurality of gripping components 116 and may continue using the first closed position for the plurality of gripping components 116. In another non-limiting example, first closed position and previously used first closed position may be different, then control module 108 may update the first closed position of a plurality of gripping components 116 to include previously used first closed position. For example, and without limitation, if first closed position includes arc length of 10 millimeters and previously used first closed position includes arc length of 5 millimeters, then control module 108 may update the first closed position to include arc length of 5 millimeters.

With continued reference to FIG. 1, in some embodiments, control module 108 may update first closed position as a function of difference between first closed position and previously used first closed position using a first difference threshold. For the purposes of this disclosure, a “first difference threshold” is a limit of the value of the difference between a first closed position and a previously used first closed position of gripping components. As a non-limiting example, first difference threshold may include any value of a closed position of gripping components 116. In some cases, first difference threshold may be manually input by a user. As a non-limiting example, first difference threshold may be predetermined. In some cases, first difference threshold may be stored in a database 140. In some cases, first difference threshold may be retrieved from a database 140. In some cases, if an absolute value of the difference between first closed position and previously used first closed position includes a value larger than first difference threshold, control module 108 may update the first closed position. In some cases, if an absolute value of the difference between first closed position and previously used first closed position includes a value smaller or equal to first difference threshold, control module 108 may not update the first closed position. In a non-limiting example, if first difference threshold includes 1 millimeters for arc length and difference between first closed position and previously used first closed position includes 1.5 millimeters for arc length, then control module 108 may update the first closed position. In some embodiments, if control module 108 updates first closed position of gripping components 116, then control module 108 may update open position and/or partially open position of the gripping components 116 accordingly. In a non-limiting example, if first closed position of gripping components 116 includes the arc length of 5 millimeters and open position includes 20 millimeters and control module 108 updates the first closed position to 3.5 millimeters, then control module 108 may update open position of the gripping components 116 to 18.5 millimeters.

With continued reference to FIG. 1, in some embodiments, control module 108 may be configured to calculate a difference between a second closed position and a previously used second closed position of a plurality of gripping components 116, wherein the second closed position comprises different closed position than the previously used closed position. For the purposes of this disclosure, a “previously used second closed position” is a second closed position of gripping components that is used for previous operation of an apparatus. In some cases, previously used closed position may be stored in a database 140. In some cases, previously used closed position may be retrieved from a database 140. In some cases, a user may manually input previously used closed position. As a non-limiting example, previously used closed position may be predetermined. In some cases, control module 108 may compare any numerical values of second closed position and previously used closed position. In a non-limiting example, second closed position and previously used closed position may be equivalent, then control module 108 may not update the second closed position of a plurality of gripping components 116 and may continue using the second closed position for the plurality of gripping components 116. In another non-limiting example, second closed position and previously used closed position may be different, then control module 108 may update the second closed position of a plurality of gripping components 116 to include previously used closed position. For example, and without limitation, if second closed position includes arc length of 10 millimeters and previously used closed position includes arc length of 5 millimeters, then control module 108 may update the second closed position to include arc length of 5 millimeters.

With continued reference to FIG. 1, in some embodiments, control module 108 may update second closed position as a function of difference between second closed position and previously used closed position using a second difference threshold. For the purposes of this disclosure, a “second difference threshold” is a limit of the value of the difference between a second closed position and a previously used closed position of gripping components. As a non-limiting example, second difference threshold may include any value of a closed position of gripping components 116. In some cases, second difference threshold may be manually input by a user. As a non-limiting example, second difference threshold may be predetermined. In some cases, second difference threshold may be stored in a database 140. In some cases, second difference threshold may be retrieved from a database 140. In some cases, if an absolute value of the difference between second closed position and previously used closed position includes a value larger than second difference threshold, control module 108 may update the second closed position. In some cases, if an absolute value of the difference between second closed position and previously used closed position includes a value smaller or equal to second difference threshold, control module 108 may not update the second closed position. In a non-limiting example, if second difference threshold includes 1 millimeters for arc length and difference between second closed position and previously used closed position includes 1.5 millimeters for arc length, then control module 108 may update the second closed position. In some embodiments, if control module 108 updates second closed position of gripping components 116, then control module 108 may update open position and/or partially open position of the gripping components 116 accordingly. In a non-limiting example, if second closed position of gripping components 116 includes the arc length of 5 millimeters and open position includes 20 millimeters and control module 108 updates the second closed position to 3.5 millimeters, then control module 108 may update open position of the gripping components 116 to 18.5 millimeters.

With continued reference to FIG. 1, in some embodiments, control module 108 may be configured to determine a partially open position of gripping components 116 for a partially open configuration as a function of a second closed position. For the purposed of this disclosure, a “partially open position” is the specific placement of gripping components required to be in a partially open configuration of gripping components. As a non-limiting example, partially open position of gripping components 116 may include a specific number, distance, amount, or value of rotation (rotary motion) of rotary component 112 to lead gripping component 116 to be in a partially open configuration. In some cases, a specific number, distance, amount, or value of rotation (rotary motion) of rotary component 112 may lead a certain partially open position of gripping components 116. For example, and without limitation, partially open position may include angular displacement, arc length, the number of rotation of rotary motion, direction of rotary motion, or the like. For example, and without limitation, partially open position may include angular displacement of 60 degree in clockwise direction of rotary motion of rotary component 112 for gripping components in a certain partially open configuration. In some cases, control module 108 may determine partially open position of gripping components 116 to be larger than the thickness of gripping object 124. In a non-limiting example, control module 108 may determine partially position of gripping component 116 to include a set amount of angular displacement, arc length, the number of rotation, or the like more than closed position, where the set amount of angular displacement, arc length, the number of rotation, or the like may be predefined by a user. Continuing the non-limiting example, the set amount of above may be smaller than the set amount of above for determining open position of gripping component 116. In some cases, the set amount of angular displacement, arc length, the number of rotation, or the like may be stored in a database 140. In some cases, the set amount of angular displacement, arc length, the number of rotation, or the like may be retrieved from a database 140.

With continued reference to FIG. 1, in some embodiments, apparatus 100 may further include a pusher mechanism 144. For the purposes of this disclosure, a “pusher mechanism” is a mechanical system that is designed to apply a pushing force to a gripping object. In some embodiments, pusher mechanism 144 may be configured to push gripping object 124 out of gripping components 116, where the gripping components 116 may be in partially open configuration. In a non-limiting example, if gripping object 124 includes a microscopic slide that includes a sticky surface, then gripping object 124 may stick to gripping components 116 and the gripping component 116 may not be able to drop the gripping object 124 onto a remote device. Continuing the non-limiting example, if gripping object 124 is stuck to gripping components 116, control module 108 may execute a control signal to use pusher mechanism 144 to push the gripping object 124 out of the gripping components 116, where the gripping components 116 may be in partially open configuration. In some embodiments, control module 108 may be configured to receive data related to whether gripping object 124 is stuck to gripping components 116 from sensor 138. For example, and without limitation, sensor 138 may include proximity sensor, tactile sensor, piezoelectric sensor, or the like. In some embodiments, control module 108 may receive data related to whether gripping object 124 is stuck to gripping components 116 from a sensor 138 when gripping components 116 are in an open configuration to drop the gripping object 124. In a non-limiting example, if the gripping object 124 is detected to be stuck to gripping components 116 using sensor 138 and transmitted to control module 108, control module 108 may execute a control signal to change the gripping components 116 in the open configuration to be in a partially open configuration, implement pusher mechanism 144 to push the gripping object 124 out of the gripping components 116. For the purposes of this disclosure, a “remote device” is a device that is external to a control module and an apparatus 100. In some embodiments, remote device may be configured to receive a gripping object 124 from gripping component 116. In some embodiments, remote device may be configured to examine, use, or the like gripping object 124. As a non-limiting example, remote device may include scanner, microscope, or the like.

Referring now to FIG. 2A, an exemplary embodiment of an apparatus 100 for a mechanism that converts rotary motion into linear motion in an open configuration is illustrated. Rotary component 112 is configured to generate rotary motion about a rotational axis 200 passing through a center of the rotary component 112 perpendicular to a surface of the rotary component 112. In some cases, rotary component 112 may be configured to rotate clockwise and/or counter-clockwise direction about rotational axis 200 passing through the center of rotary component 112 perpendicular to the surface of rotary component 112. In a non-limiting example, rotary component 112 may rotate clockwise direction about rotational axis 200 passing through the center of rotary component 112 perpendicular to the surface of rotary component 112 to move a plurality gripping components 116 into an open configuration.

With continued reference to FIG. 2A, for example, and without limitation, rotating rotary component 112 (rotary motion) in clockwise direction about rotational axis 200 passing through the center of rotary component 112 perpendicular to the surface of rotary component 112 may lead to the movement of movable component 120 in off-axis motion as movable component 120 may be fixedly connected or movably connected to rotary component 112 using first connecting component 136a, then off-axis motion of movable component 120 may lead the movement of gripping component 116 in linear motion as a second end of movable component 120 and a first end of gripping component 116 may be fixedly connected or movably connected using second connecting component 136b, where the linear motion of gripping component 116 may move first gripping component 116a and second gripping component 116b in opposite direction to each other, increasing the gap between second ends of first gripping component 116a and second gripping component 116b (open configuration). In a non-limiting example, rotary component 112 may rotate in a clockwise direction about rotational axis 200 passing through the center of rotary component 112 perpendicular to the surface of rotary component 112 to move a plurality gripping components 116 into open configuration.

Referring now to FIG. 2B, an exemplary embodiment of an apparatus 100 for a mechanism that converts rotary motion into linear motion in a closed configuration is illustrated. Rotary component 112 is configured to generate rotary motion about an rotational axis 200 passing through a center of the rotary component 112 perpendicular to a surface of the rotary component 112. In some cases, rotary component 112 may be configured to rotate clockwise and/or counter-clockwise direction about rotational axis 200 passing through the center of rotary component 112 perpendicular to the surface of rotary component 112. In a non-limiting example, rotary component 112 may rotate counter-clockwise direction about rotational axis 200 passing through the center of rotary component 112 perpendicular to the surface of rotary component 112 (any rotational axis thereof) to move a plurality gripping components 116 into a closed configuration.

With continued reference to FIG. 2B, for example, and without limitation, rotating rotary component 112 (rotary motion) in counter-clockwise direction about rotational axis 200 passing through the center of rotary component 112 perpendicular to the surface of rotary component 112 (any rotational axis thereof) may lead to the movement of movable component 120 in off-axis motion as movable component 120 may be fixedly connected or movably connected to rotary component 112 using first connecting component 136a, then off-axis motion of movable component 120 may lead the movement of gripping component 116 in linear motion as a second end of movable component 120 and a first end of gripping component 116 may be fixedly connected or movably connected using second connecting component 136b, where the linear motion of gripping component 116 may move first gripping component 116a and second gripping component 116b in opposite direction to each other, decreasing the gap between second ends of first gripping component 116a and second gripping component 116b (closed configuration). In a non-limiting example, rotary component 112 may rotate counter-clockwise direction about rotational axis 200 passing through the center of rotary component 112 perpendicular to the surface of rotary component 112 (any rotational axis thereof) to move a plurality gripping components 116 into a closed configuration.

With continued reference to FIGS. 2A-B, in some embodiments, actuator 104 may include a plurality of movable components 120. As a non-limiting example, actuator 104 may include first movable component 120a and second movable component 120b as illustrated in FIGS. 2A-B. In some embodiments, actuator 104 may include a plurality of connecting components 136. As a non-limiting example, actuator 104 may include a first connecting component 136a that fixedly connects or movably connects two or more components. As another non-limiting example, actuator 104 may include a second connecting component 136b that movable connects two or more components. In some embodiments, apparatus 100 may include a guiding component 132. As a non-limiting example, guiding component 132 may include bearings, guides, rails, sliders, or the like. In some cases, guiding component 132 may be configured to provide linear guidance, meaning it may direct gripping components 116 to move in linear motion along a specified path. In some cases, guiding component 132 may be configured to maintain the alignment of gripping components 116, preventing deviations or misalignment during linear motion.

Referring now to FIGS. 3A-D, FIG. 3A illustrates exemplary embodiments of a plurality of gripping components 116 in open position of open configuration. FIG. 3B illustrates an exemplary embodiment of a plurality of gripping components 116 in a second closed position of closed configuration holding a gripping object 124. FIG. 3C illustrates an exemplary embodiment of a plurality of gripping components 116 in a first closed position of closed configuration without holding a gripping object 124. In a non-limiting example, first closed position of closed configuration may be used for calibration of gripping components 116 that involves mapping the position of gripping components 116 to the current drawn by a motor as described with respect to FIG. 1. The movement of gripping components 116 may be controlled by a gripper base 300 that houses an assembly consisting of at least a motor, at least an actuator 104, such as but not limited to rotary component 112, movable component 120, connecting component 136, bearings, guiding component 132, sliders, control module 108, and/or the like. In some cases, gripping components 116 may include a grip enhancing component 128. In some cases, each of a plurality of gripping components 116 may include grip enhancing component as illustrated in FIGS. 3A-C. In some cases, grip enhancing component 128 may be attached, inserted, embedded, coated, or the like to gripping component 116. In a non-limiting example, grip enhancing component 128 may include rubber coating, textured surface, foam, adhesive tape or pad, vacuum or suction cup, magnetic gripper, or the like. In some embodiments, grip enhancing component 128 may be configured to create large surface area of contact between gripping components 116 and gripping object 124. In some embodiments, grip enhancing component 128 may be configured to increase a coefficient of friction between gripping components 116 and gripping object 124. FIG. 3D illustrates an exemplary embodiment of one of a plurality of gripping components 116 missing a grip enhancing component 128 in a closed configuration. In a non-limiting example, missing one grip enhancing component 128 of a plurality of gripping components 116 may be detected using sensor 138 and transmitted to a control module 108. Continuing the non-limiting example, the detection may trigger calibration of gripping components 116 as described with respect to FIG. 1. In some cases, gripping components 116 may be configured to hold a gripping object 124 even if one grip enhancing component 128 is missing.

Referring now to FIGS. 4A-F, exemplary embodiments of a plurality of gripping components 116 placing a gripping object 124 on a remote device are illustrated. In some embodiments, gripping components 116 may be configured to place gripping object 124 on a stage 400 of remote device. For the purposes of this disclosure, a “stage” is a component of a remote device that serves as the platform or support structure for holding and positioning a gripping object or specimens. As a non-limiting example, stage 400 may include microscope stage, XY stage, or the like. Gripping components 116 may place gripping object 124 on any surface. In a non-limiting example, gripping components 116 in a closed configuration may carry gripping object 124 to place the gripping object 124 on remote device, such as but not limited to stage 400 as shown in FIG. 4A. In another non-limiting example, gripping components 116 may be moved, using rotary motion of rotary component 112 transferred to linear motion of gripping components 116 using connecting components 136 and movable components 120, to open configuration to place gripping object 124 on stage 400 as shown in FIG. 4B. In some embodiments, gripping object 124 may be sticky, and it may stick to gripping components 116 when the gripping components 116 hold the sticky gripping object 124 in closed configuration. Continuing the non-limiting example, when the gripping components 116 linearly moves in opposite directions to increase the gap between the gripping components 116 to place the sticky gripping object 124 on stage 400, the sticky gripping object may be dropped on the stage 400 as shown in FIG. 4C. In a non-limiting example, in such case, sensor 138 may detect that gripping object 124 is stuck to gripping components 116 using a sensor 138 and transmit data related to the detection to control module 108. Then, in a non-limiting example, control module 108 may execute a control signal to move gripping components 116 to partially open configuration as shown in FIG. 4D. Control module 108, then, continuing the non-limiting example, may execute a control signal to use a pusher mechanism 404 to push gripping object 124 that is stuck to the gripping components 116, placing the gripping object on the stage 400 as shown in FIG. 4E. In a non-limiting example, gripping components 116 may move to open configuration after gripping object 124 is pushed using pusher mechanism 404 as shown in FIG. 4F. Pusher mechanism 404 may be consistent with pusher mechanism 144 described with respect to FIG. 1.

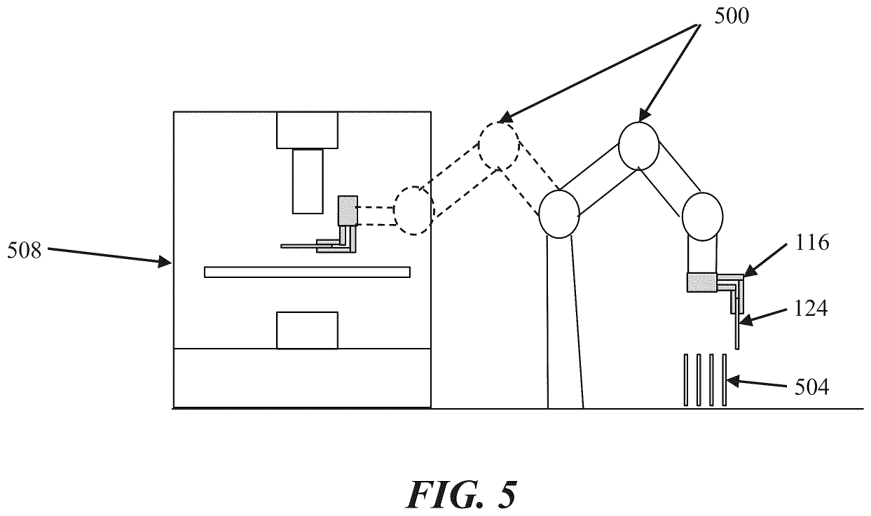

Referring now to FIG. 5, an exemplary embodiment of the use of an apparatus 100 for a mechanism that converts rotary motion into linear motion is illustrated. FIG. 5 illustrates a robotic arm 500 implementing an apparatus 100, gripping object storage 504 and remote device 508. In some cases, apparatus 100 may be implemented in a robotic arm 500. For the purposes of this disclosure, a “robotic arm” is a mechanical device or manipulator that mimics the structure and function of a human arm. In some cases, apparatus 100 may be implemented in any other devices. For the purposes of this disclosure, a “gripping object storage” is a container that stores a gripping object. As a non-limiting example, gripping object storage 504 may include a container for picking gripping object 124 up using gripping components 116 or for dropping gripping object 124 off after use. As a non-limiting example, remote device 508 may include scanner, microscope, or the like. In a non-limiting example, a robotic arm 500 that implements apparatus 100 may pick up gripping object 124 from a first gripping object storage 504 (robotic arm 500 in solid line as shown in FIG. 5), carry the gripping object 124 to remote device 508 and place the gripping object 124 on the remote device 508 (robotic arm 500 in dashed line as shown in FIG. 5). Then, continuing the non-limiting example, the robotic arm 500 may pick the gripping object 124 from the remote device 508, carry the gripping object 124 to a second gripping object storage 504 and drop the gripping object 124 off to the second gripping object storage 504. This may be repeated until there is no gripping object 124 to pick up in the first gripping object storage 504.

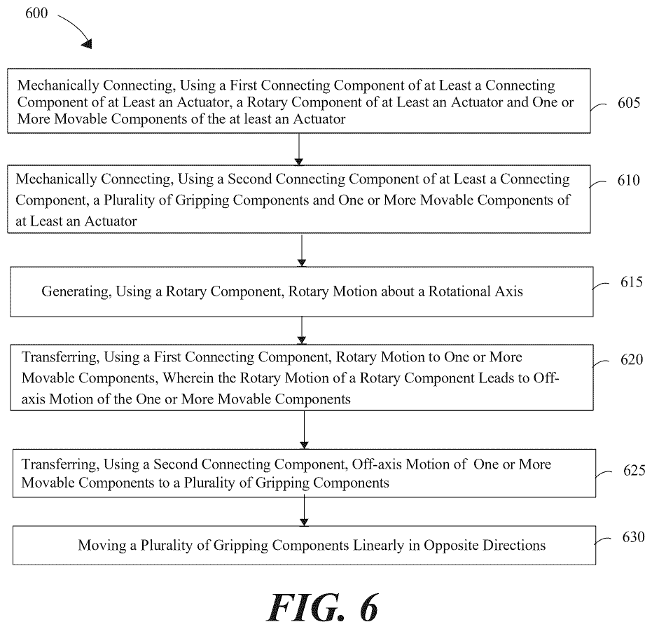

Referring now to FIG. 6, a flow diagram of an exemplary method 600 of use of a mechanism that converts rotary motion into linear motion. Method 600 includes a step 605 of mechanically connecting, using a first connecting component of at least a connecting component of at least an actuator, a rotary component of at least an actuator and one or more movable components of the at least an actuator. In some embodiments, method 600 may further include fixedly connecting, using the first connecting component, the rotary component and a first end of the one or more movable components and fixedly connecting, using the second connecting component, the plurality of gripping components and a second end of the one or more movable components. This may be implemented as disclosed with respect to FIGS. 1-5.

With continued reference to FIG. 6, method 600 includes a step 610 of mechanically connecting, using a second connecting component of at least a connecting component, a plurality of gripping components and one or more movable components of at least an actuator. This may be implemented as disclosed with respect to FIGS. 1-5.

With continued reference to FIG. 6, method 600 includes a step 615 of generating, using a rotary component, rotary motion on a rotational axis. In some embodiments, method 600 may further include rotating the rotary component in a first direction about the rotational axis, wherein the rotary motion of the rotary component in the first direction moves the plurality of gripping components into a closed configuration as a first gripping component gets pulled while, concurrently, a second gripping component gets pushed. This may be implemented as disclosed with respect to FIGS. 1-5.

With continued reference to FIG. 6, method 600 includes a step 620 of transferring, using a first connecting component, rotary motion to one or more movable components, wherein the rotary motion of a rotary component leads to off-axis motion of the one or more movable components. This may be implemented as disclosed with respect to FIGS. 1-5.

With continued reference to FIG. 6, method 600 includes a step 625 of transferring, using a second connecting component, off-axis motion of one or more movable components to a plurality of gripping components. This may be implemented as disclosed with respect to FIGS. 1-5.

With continued reference to FIG. 6, method 600 includes a step 630 of moving a plurality of gripping components linearly in opposite directions. This may be implemented as disclosed with respect to FIGS. 1-5.

With continued reference to FIG. 6, in some embodiments, method 600 may further include receiving, using a control module, a gripping force of a plurality of gripping components from at least a sensor, wherein the at least a sensor detects the gripping force as a function of current drawn by a motor mechanically connected to a rotary component, wherein the plurality gripping components comprises a gripping threshold and executing, using the control module, a control signal for the plurality of gripping components to hold a gripping object using the gripping force within the gripping threshold. In some embodiments, method 600 may further include receiving, using the control module, a first closed position of the plurality of gripping components in a closed configuration without holding the gripping object using rotary motion of the rotary component from the at least a sensor and determining, using the control module, an open position of the plurality of gripping components in an open configuration as a function of the first closed position. In some embodiments, method 600 may further include receiving, using the control module, a second closed position of the plurality of gripping components in the closed configuration holding the gripping object from the at least a sensor and estimating, using the control module, a thickness of the gripping object as a function of a difference between the first closed position and the second closed position. In some embodiments, method 600 may further include calculating, using the control module, a difference between the second closed position and a previously used closed position of the plurality of gripping components, wherein the second closed position comprises different closed position than the previously used closed position and updating, using the control module, the second closed position of the plurality of gripping components as a function of the difference. In some embodiments, method 600 may further include determining, using the control module, a partially open position of the plurality of gripping components for a partially open configuration as a function of the second closed position. In some embodiments, method 600 may further include increasing, using a grip enhancing component, a coefficient of friction between the plurality of gripping components and the gripping object. In some embodiments, method 600 may further include guiding, using a guiding component, the plurality gripping components to the linear motion. These may be implemented as disclosed with respect to FIGS. 1-5.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

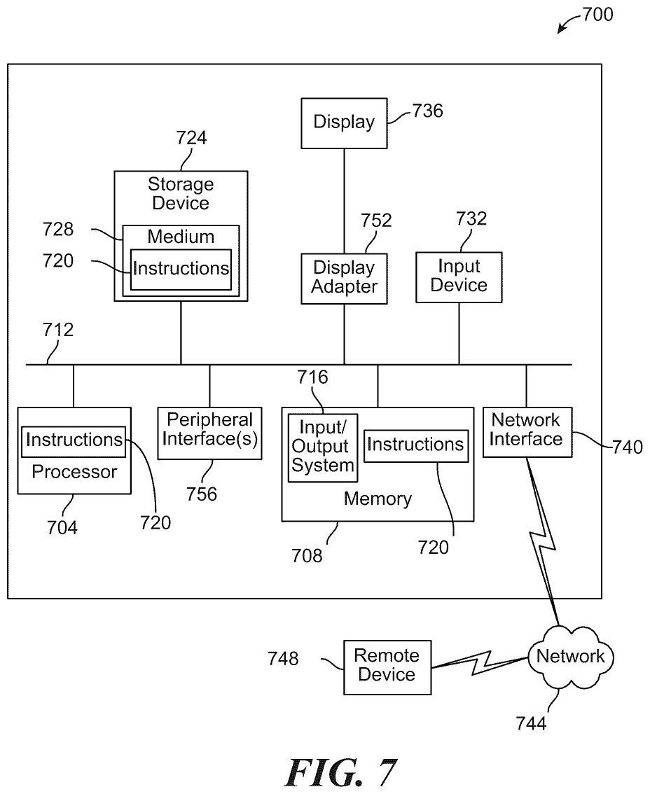

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and memory 708 that communicate with each other, and with other components, via a bus 712. Bus 712 may include any of several types of bus structures including, but not limited to, memory bus, memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and apparatuses according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method of use of a mechanism that converts rotary motion into linear motion, the method comprising:
mechanically connecting, using a first connecting component of at least a connecting component of at least an actuator, a rotary component of at least an actuator and one or more movable components of the at least an actuator;
mechanically connecting, using a second connecting component of the at least a connecting component, a plurality of gripping components and the one or more movable components of the at least an actuator;
generating, using the rotary component, rotary motion about a rotational axis;
transferring, using the first connecting component, the rotary motion to the one or more movable components, wherein the rotary motion of the rotary component leads to off-axis motion of the one or more movable components;
transferring, using the second connecting component, the off-axis motion of the one or more movable components to the plurality of gripping components; and
moving the plurality of gripping components linearly in opposite directions.

2. The method of claim 1, further comprising:
movably connecting, using the first connecting component, the rotary component and a first end of the one or more movable components; and
movably connecting, using the second connecting component, the plurality of gripping components and a second end of the one or more movable components.

3. The method of claim 1, further comprising:
rotating the rotary component in a first direction about the rotational axis, wherein the rotary motion of the rotary component in the first direction moves the plurality of gripping components into a closed configuration as a first gripping component gets pulled while, concurrently, a second gripping component gets pushed.

4. The method of claim 1, further comprising:
receiving, using a control module, a gripping force of the plurality of gripping components from at least a sensor, wherein the at least a sensor detects the gripping force as a function of current drawn by a motor mechanically connected to the rotary component, wherein the plurality gripping components comprises a gripping threshold; and
executing, using the control module, a control signal for the plurality of gripping components to hold a gripping object using the gripping force within the gripping threshold.

5. The method of claim 1, further comprising:
receiving, using the control module, a first closed position of the plurality of gripping components in the closed configuration without holding the gripping object using the rotary motion of the rotary component from the at least a sensor; and
determining, using the control module, an open position of the plurality of gripping components in an open configuration as a function of the first closed position.

6. The method of claim 5, further comprising:
receiving, using the control module, a second closed position of the plurality of gripping components in the closed configuration holding the gripping object from the at least a sensor; and
estimating, using the control module, a thickness of the gripping object as a function of a difference between the first closed position and the second closed position.

7. The method of claim 6, further comprising:
calculating, using the control module, a difference between the second closed position and a previously used closed position of the plurality of gripping components, wherein the second closed position comprises different closed position than the previously used closed position; and
updating, using the control module, the second closed position of the plurality of gripping components as a function of the difference.

8. The method of claim 6, further comprising:
determining, using the control module, a partially open position of the plurality of gripping components for a partially open configuration as a function of the second closed position.

9. The method of claim 1, further comprising:
increasing, using a grip enhancing component, a coefficient of friction between the plurality of gripping components and the gripping object.

10. The method of claim 1, further comprising:
guiding, using a guiding component, the plurality gripping components in linear motion.

11. An apparatus of a mechanism that converts rotary motion into linear motion, the apparatus comprising:
at least an actuator configured to generate linear motion of a plurality of gripping components, wherein the at least an actuator comprises:
a rotary component, wherein the rotary component is configured to generate rotary motion about a rotational axis;
one or more movable components, wherein the rotary motion of the rotary component leads to off-axis motion of the one or more movable components; and
at least a connecting component comprising:
a first connecting component, wherein the first connecting component is configured to:
mechanically connect the rotary component and the one or more movable components; and
transfer the rotary motion of the rotary component to the one or more movable component; and
a second connecting component, wherein the second connecting component is configured to:
mechanically connect the plurality of gripping components and the one or more movable components; and
transfer the off-axis motion of the one or more movable components to the plurality of gripping components;
the plurality of gripping components, wherein the plurality of gripping components are configured to move linearly in opposite directions; and
a control module comprising a system on a chip (SoC), wherein the control module is configured to:
receive a gripping force of the plurality of gripping components from at least a sensor, wherein the at least a sensor detects the gripping force as a function of current drawn by a motor mechanically connected to the rotary component, wherein the plurality of gripping components comprises a gripping threshold, wherein each gripping component comprises a specific gripping threshold based on a thickness of a gripping object; and
execute a control signal for the plurality of gripping components to hold a gripping object using the gripping force within the gripping threshold.

12. The apparatus of claim 11, wherein:
the first connecting component is configured to movably connect the rotary component and a first end of the one or more movable components; and
the second connecting component is configured to movably connect the plurality of gripping components and a second end of the one or more movable components.

13. The apparatus of claim 11, wherein the rotary component is configured to rotate about the rotational axis in a first direction, wherein the rotary motion of the rotary component in the first direction moves the plurality of gripping components into a closed configuration as a first gripping component gets pulled while, concurrently, a second gripping component gets pushed.

14. (canceled)

15. The apparatus of claim 11, wherein the control module is further configured to:
receive a first closed position of the plurality of gripping components in the closed configuration without holding the gripping object using the rotary motion of the rotary component from the at least a sensor; and
determine an open position of the plurality of gripping components in an open configuration as a function of the first closed position.

16. The apparatus of claim 15, wherein the control module is further configured to:
receive a second closed position of the plurality of gripping components in the closed configuration holding the gripping object from the at least a sensor; and
estimate a thickness of the gripping object as a function of a difference between the first closed position and the second closed position.

17. The apparatus of claim 16, wherein the control module is further configured to:
calculate a difference between the second closed position and a previously used closed position of the plurality of gripping components, wherein the second closed position comprises different closed position than the previously used closed position; and
update the second closed position of the plurality of gripping components as a function of the difference.

18. The apparatus of claim 16, wherein the control module is further configured to determine a partially open position of the plurality of gripping components for a partially open configuration as a function of the second closed position, wherein, in the partially open position, the plurality of gripping components are not fully closed and are capable of opening further.

19. The apparatus of claim 11, further comprising:
a grip enhancing component, wherein the grip enhancing component is configured to increase a coefficient of friction between the plurality of gripping components and the gripping object.

20. The apparatus of claim 11, further comprising:
a guiding component, wherein the guiding component is configured to guide the plurality of gripping components in linear motion.
